(19) United States
(12) Patent Application Publication
(10) Pub. No.: US 2006/0039777 A1
(43) Pub. Date: Feb. 23, 2006

(54) Stamped rivet for connection to sheet metals and method for placing said stamped rivet

(75) Inventor: Erich Palm, Au (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: SFA intec Holding AG, Heerbrugg (CH)

(21) Appl. No.: 10/536,657

(22) PCT Filed: Dec. 16, 2003
(86) PCT No.: PCT/EP03/14302

§ 371 Date: May 27, 2005

(30) Foreign Application Priority Data
Dec. 18, 2002 (DE) 10259334.5

(51) Int. Cl. F16B 15/08

(52) U.S. Cl. 411/455

(57) ABSTRACT

A stamped rivet (10) has a head (12), a shaft (14), a circumferential groove formed therein and a shaft end (18). The head is provided with a ring-shaped planar surface (20). The circumferential groove (16) is directly adjacent to the lower side of the head (12). One section (22) of the shaft is conically tapered in an area located between the circumferential groove (16) and the end (18) of the shaft in the direction of the end of the shaft. The axial length (L) of the circumferential groove (16) is greater than a thickness of the sheet metal or the overall thickness of the metal sheets in which the stamp rivet is to be installed. The circumferential groove (16) extends to a longitudinal center (M) of the stamped rivet (10). The length of the tapered section (22) of the shaft (14) corresponds to the axial length (L) of the circumferential groove (16). Sheet metal material, which is forced downwards and to the side during formation of a stamped hole, is plastically deformed into the circumferential groove (16) during the stamping-in process. Therefore, the axial thickness of the sheet material is greater in the deformation area than that of the starting material.

### BACKGROUND

The invention relates to a stamped rivet for connection to sheet metals, having a head with a shaft directly adjacent thereto, a circumferential groove formed in said shaft, and a shaft end opposite to the head. Further, the invention relates to a method for placing a stamped rivet according to claims 1 through 17, for connection to sheet metals with the stamped rivet without any pre-drilling being required through the sheet metal, forming a punched hole, and subsequently sheet metal material being pressed under plastic deformation into the circumferential groove by way of a counter pressure.

A stamped rivet of the type mentioned at the outset has been known from EP 1 013 945 B1. This known rivet does not only embody a stamped rivet but simultaneously an embossed rivet as well. When such a stamped/embossed rivet has punched through two components to be connected to one another, thus forming a punched hole, subsequently in the respective component a groove is cut into the end of the shaft opposite to the head of the rivet, causing material of the component located nearby to penetrate under plastic deformation into the circumferential groove formed in the shaft. For this purpose, a punching tool of the rivet placement device must be provided with a bundled coil protruding upwards, accepting the end of the shaft opposite to the head and thereby embossing the groove around the end of the shaft into the material of the component located there. The circumferential groove of this known shaft-embossed rivet is directly adjacent to the end of the shaft so that the plastic deformation occurs in the material of the lower section of the component only. The head of the stamped/embossed rivet is conically tapered and is forced into the upper component during the placement of the rivet to such an extent that the surface of the head of the placed rivet ends flush with the surface of the upper component. Due to the stamping process necessary, such a stamped/embossed rivet requires a rivet placement device with an appropriately extensive design. Additionally, sufficient material can only be formed into the circumferential groove by way of stamping if the components to be connected are sufficiently thick. The stamped/embossed rivet known is obviously neither suggested nor suitable for the connection of thin sheet metals to one another or the mounting in a thin sheet metal.

A similar stamped/embossed rivet is known from U.S. Pat. No. 3,909,913. This stamped/embossed rivet varies from the above-mentioned one primarily in a slightly different shape of the head and the circumferential groove. However, U.S. Pat. No. 3,909,913 additionally shows the structure of the punching tool used for the punching process.

DE 297 07 669 U1 describes a punched rivet, which also relates to a punched/embossed rivet according to the above-mentioned definition. This publication shows an old construction of such a stamped/embossed rivet, in which the circumferential groove is arranged closer to the separating point of two components to be connected to one another than in the stamped/embossed rivet according to EP 1 013 945 B1, so that material of the lower part of the component is plastically deformed into the circumferential groove not only due to the punching process, rather material of the upper component is also deformed into the circumferential groove by the conically tapered head of the rivet. However, this known stamped rivet is not suitable for connection of thin sheet metals either, because sufficient material for the two above-mentioned deformation processes cannot be provided.

From U.S. Pat. No. 4,130,922 a stamped/embossed rivet is known, by which thin components or sheet metals can be connected to one another, however, for the placement of said rivet both the punching tool as well as the corresponding male counterpart must be provided so that a groove is not only punched around the end of the shaft in the component located here, but also a groove around the head of the rivet in the other component.

The respective prior art is also shown in U.S. Pat. No. 5,678,970, in which both the punching tool as well as its male counterpart are provided. When only the punching tool is provided, a rivet is used, in which the head is provided with a larger diameter than the end of the shaft. The head is countersunk flush with the upper component during the placement process, and a groove is only punched around the end of the shaft in the lower component.

From U.S. Pat. No. 4,978,270 a headless stamped/embossed rivet is known, which requires not only a punching tool and a corresponding male counterpart, but itself is additionally provided with several circumferential grooves. It allows the connection of three components arranged above one another.

Finally, DE 43 33 053 C2 shows a self-stamping fastening device, in which the rivet comprises a rivet head and a rivet shaft having a central recess, with its open facial surface not completely penetrating an accepting metal sheet. Such a rivet is neither intended nor suitable for a placement in thin sheet metals.

For the connection to sheet metal, not only stamped rivets are known connecting two or more sheet metals to one another, but also embossed rivets, which are to be fastened to a sheet metal with the head of such embossed rivets, e.g., being embodied in the form of a support pin. (U.S. Pat. No. 3,571,903). Here, the shaft can be embodied such that during the placement process the sheet metal material surrounding the shaft is displaced upwards and is subsequently pushed back down by the support pin component of the embossed rivet, in order to be forced into the circumferential groove by way of plastic deformation and, thus, the embossed rivet contacting the metal sheet in a formfitting manner. Such embossed rivets cannot be placed into thin sheet metals, either. Although there is an embodiment in the embossed rivet known, having a tapered section of the shaft in an area between the circumferential groove and the end of the shaft in the direction towards the end of the shaft, however, in this embodiment the rivet does not embody an embossed rivet but requires a pre-fabricated conical opening in the metal sheet, in which it is fastened by way of a special embodiment of the part of the shaft located above the circumferential groove via sheet metal material, which is plastically deformed into the circumferential groove.

For the placement of embossed rivets of the above-mentioned type it is also known (from U.S. Pat. No. 1,275,576) additionally to insert a male embossing tool and to form the head in the groove punched by the male embossing tool.

### SUMMARY

The object of the invention is to provide a stamped rivet of the type mentioned at the outset such that a secure connection to thin sheet metals can be produced, either in order to connect several thin sheet metals to one another or for a connection of the stamped rivet to a thin sheet metal. Further, the invention is to provide a method for the placement of such a stamped rivet.

This object is attained according to the invention in a stamped rivet of the type mentioned at the outset in which the head, at its lower side facing the shaft, is provided with a circular plan surface, that the circumferential groove is directly adjacent to the bottom side of the head, and that a section of the shaft conically tapers in the direction towards the end of the shaft in an area located between the circumferential groove and the end of the shaft.

In the stamped rivet according to the invention the thickest part of the shaft is located in an area between the circumferential groove and the end of the shaft, so that the plastic deformation of the sheet metal material into the circumferential groove occurs immediately below the head and that the section can be formed conically tapering from the thickest part of the shaft to the end of the shaft which can be provided appropriate for the purpose of aiming at an efficient stamping effect. Below the head, the length of the shaft of the stamped rivet is here considerably longer than the thickness of the metal sheet of the total thickness of the sheet metals, to which a connection is to be made. In order to produce such a connection, it is only required that the material displaced in the stamped direction during the formation of the stamped hole is forced back during the placement process such that it is plastically deformed into the circumferential groove.

Advantageous embodiments of the stamped rivet according to the invention are represented in the sub claims.

If in one advantageous embodiment of the stamped rivet according to the invention, the tapering section extends to a cylindrical end section of the shaft, depending on length and diameter, the end section can be developed particularly efficient for the stamping process.

When in another embodiment of the stamped rivet according to the invention the tapering section extends to the end of the shaft, the end of the shaft can for example taper to a point, so that less pressure is required for the stamping process.

When in another embodiment of the stamped rivet according to the invention the tapered section is located directly adjacent to the circumferential groove, a shorter overall length of the stamped rivet can be realized.

When in another embodiment of the stamped rivet according to the invention a cylindrical section of the shaft follows immediately adjacent to the circumferential groove and extends to the tapering section of the shaft, the section of the shaft protruding after the placing process can be used as a support pin or the like regardless if a connection to one or more sheet metals has been made.

When in another embodiment of the stamped rivet according to the invention the circumferential groove extends to the longitudinal center of the stamped rivet, sufficient axial length for the plastic deformation of the sheet metal material into the circumferential groove is provided for use in thin sheet metal material in order to provide a secure, form fitting fastening of the stamped rivet according to the invention.

When in another embodiment of the stamped rivet according to the invention the tapering section of the shaft has an axial length essentially identical to the axial length of the circumferential groove, the area located between the circumferential groove and the end of the shaft can be designed for a particularly efficient stamping process and/or for the use of the placed stamped rivet as a support point or the like.

The connection of the stamped rivet to a sheet metal can be perfectly adjusted to the thickness and type of the sheet metal material and to the purpose of the stamped rivet when, in another embodiment of the stamped rivet according to the invention, the circumferential groove blends via its first radius with the plane surface at a bottom side of the head and/or the circumferential groove is at the base parallel with regard to a central area of the longitudinal axis of the stamped rivet and/or the circumferential groove blends with a straight line tilted in reference to the longitudinal axis of the stamped rivet with a subsequent section of the shaft and/or the base of the circumferential groove blends via a second radius into the straight line and/or the circumferential groove blends via a third radius with a subsequent section of the shaft and/or the tapering section blends via a fourth radius with the cylindrical final section and/or the cylindrical section of the shaft blends via a fifth radius with the tapering section.

When in another embodiment of the stamped rivet according to the invention the stamped rivet is provided with sharp edges, the stamping process can be perfectly designed for the desired plastic deformation of the metal sheet material into the circumferential groove.

When in another embodiment of the stamped rivet according to the invention the cylindrical end section of the shaft has a diameter equal to the smallest or slightly smaller than the smallest diameter of the shaft in the area of the circumferential groove, the amount of the sheet metal material around the punched hole displaced during the stamping process outward and in the stamped direction, and to be plastically deformed into the circumferential groove can be optimally predetermined.

When in another embodiment of the stamped rivet according to the invention an axial length of the circumferential groove is greater than the thickness of the sheet metal or the overall thickness of the sheet metals, to which a connection is to be made, a secure connection even to a thin sheet metal can be produced using the stamped rivet according to the invention.

With respect to the methods mentioned at the outset, the object is attained according to the invention such that the sheet metal material in a circular area around the punched hole is displaced in the stamped direction by the stamped rivet, that subsequently the sheet metal material is displaced upward by a counter force acting from the bottom onto the stamped rivet, that subsequently the stamped rivet is forced farther downward through the punched hole until the head contacts the sheet metals with its plane surface and that finally the sheet metal material displaced in the stamped direction is plastically deformed into the circumferential groove by way of the counter force.

### BRIEF DESCRIPTION OF THE DRAWINGS

In the following, exemplary embodiments of the invention are explained in greater detail using the drawings. They show:

FIGS. 1a-1c show a first embodiment of the stamped rivet according to the invention in a side view, a top view, and/or a perspective representation.

FIG. 2a shows a stamped rivet according to FIGS. 1a-1c for the connection of two sheet metals in a placed state, with additionally one detail of a device for placement of the stamped rivet being shown.

FIG. 2ba shows a second embodiment of the stamped rivet according to the invention for the connection of two sheet metals to one another, again in positioned state.

FIG. 3 shows a first embodiment of the device for placement of the stamped rivet according to the invention, and

FIG. 4 shows a second embodiment of the device for placement of the stamped rivet according to the invention, here arranged with another stamped rivet in a magazine strip.

### DETAILED DESCRIPTION OF THE PREFERRED EMBODIMENTS

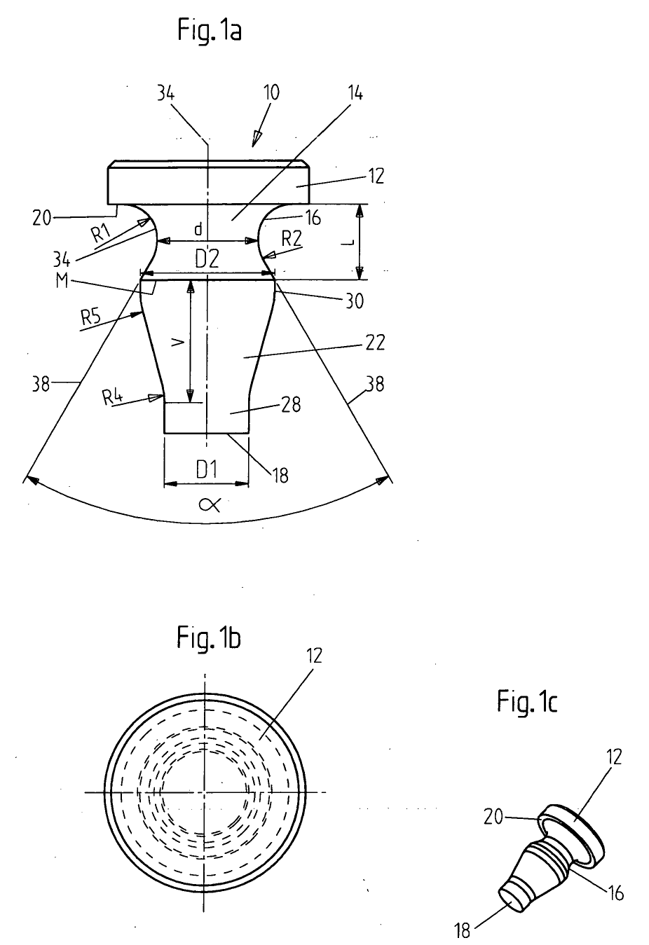

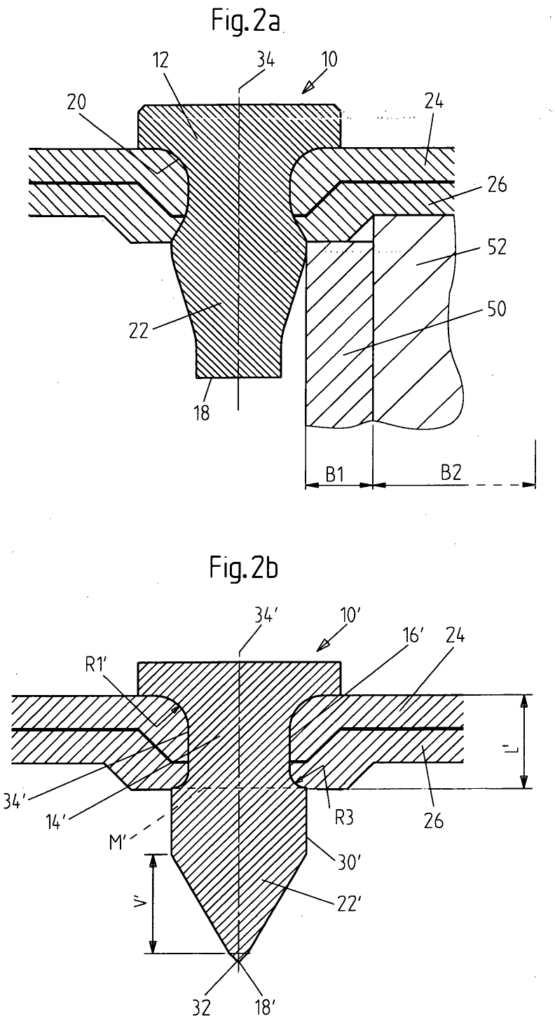

FIG. 1a shows a top view of a first embodiment of a stamped rivet according to the invention, indicated as 10 in its entirety. A second embodiment of the stamped rivet according to the invention is shown in FIG. 2b and named 10′ in its entirety. FIG. 2b will be explained later.

According to the drawing shown in FIGS. 1a-1c, the stamped rivet 10 has a head 12, an adjacent shaft 14, a circumferential groove 16 formed in said shaft, and a shaft end 18 opposite to the head. The head 12 is provided with a circular planar surface 20 facing the bottom. The circumferential groove 16 is directly adjacent to the bottom of the head 12. A section 22 of the shaft 14 tapers conically in an area between the circumferential groove 16 and the shaft end 18 in a direction towards the shaft end 18. In the exemplary embodiment, the head 12 is shown in the form of a pan-head, as easily discernible from FIGS. 1a and 1b, however, it may also be embodied as a button-head or the like. It is essential for the invention that the circumferential groove 16 is adjacent to the planar surface 20, with its purpose becoming obvious later.

The stamped rivet 10, 10′ described here serves for the connection of thin sheet metals, i.e. either for the connection of two thin metal sheets 24, 26 to one another, as shown in FIGS. 2a and/or 2b, or for more than two thin metal sheets (not shown). However, the stamped rivet 10, 10′ can also be fastened to one thin metal sheet. In this case, the connection were to look as shown in FIGS. 2a and 2b, merely with the difference that here the visible separator between the two sheet metals 24, 26 were not present. The single thin metal sheet could certainly be thinner than the two thin sheet metals 24, 26 combined. In any case, in the two embodiments of the stamped rivet 10 shown in FIGS. 1 and 2, the stamped rivet 10, 10′ according to the invention has an axial length L (FIG. 1a) and/or L′ (FIG. 2b) of the circumferential groove 16, which is greater than the thickness of a single metal sheet, to which the stamped rivet 10 or 10′ is to be fastened, or the combined thickness of the metal sheets 24, 26 to be connected to one another by the stamped rivet 10, 10′. In the embodiment shown in FIG. 1, the tapering section 22 of the shaft 14 extends to a cylindrical end section 28 with an exterior diameter D1. In the embodiment of the stamped rivet 10′ shown in 2b, the tapering section 32 tapers in a more pointed fashion than the section 22′ ending in a shaft end 18′ provided as a pointed tip. The tapering section 22, 22′ may be directly adjacent (not shown) to the circumferential groove 16, 16′. In the embodiments of the stamped rivet 10, 10′ shown and described here, a cylindrical shaft section 30 and/or 30′ is directly adjacent to the circumferential groove 16 and/or 16′ and extends to the tapering section 22 and 22′ of the shaft 14, respectively.

In the two embodiments of the stamped rivet 10, 10′ the circumferential grooves 16, 16′ extend to a longitudinal center M and/or M′ of the stamped rivet. The tapering section 22, 22′ of the shaft 14, 14′ has an axial length V and/or V′ generally equivalent to the axial length L and/or L′ of the circumferential groove 16, 16′. In the first embodiment of the stamped rivet 10, the tapering section having the length V is followed by the cylindrical end section 28. In the stamped rivet 10′, the tapering section 32 follows the axial length V′ of the tapering section. The overall length of the stamped rivet 10, 10′ is therefore considerably larger than and preferably more than twice as large as the overall thickness of the sheet metal material, to which the connection is to be made with or by the stamped rivet 10, 10′.

In the stamped rivet 10 as well as in the stamped rivet 10′, the circumferential groove 16, and/or 16′ having a first radius R1 converges into the planar surface 20, 20′ at the bottom of the head 12′. The circumferential groove 16, 16′ has, with reference to a longitudinal axis 34 34′ at a central area 36 of the stamped rivet 10, 10′, a base parallel to the longitudinal axis 34, 34′. In the stamped rivet 10, the circumferential groove 16 fades via a straight line 38, tilted in reference to the longitudinal axis 34 of the stamped rivet, into the adjacent cylindrical shaft section 30, which is the thickest part of the shaft 14, 14′ and has a diameter D2. In the stamped rivet 10, the base of the circumferential grove 16 converges into the straight line 38 via a second radius R2. In the stamped rivet 10′ the circumferential groove 16′ converges via a third radius R3 (FIG. 2b) into the adjacent cylindrical shaft section 30′, which is also provided with the largest shaft diameter D2. In the stamped rivet 10 the tapering section 22 converges into the cylindrical end section 28 via a fourth radius R4. Further, in the stamped rivet 10 the cylindrical shaft section 30 converges into the tapering section 22 via a fifth radius R5. The two straight lines 38, shown in FIG. 1a as diametrically opposite, form an angle α having 60°. In the stamped rivet 10 the shaft end 18 is formed with sharp edges. Finally, in the stamped rivet 10, the diameter of the cylindrical end section 28 of the shaft 14 is equivalent to the smallest or slightly smaller than the smallest diameter d of the shaft 14 in the area of the circumferential groove 16.

In the two exemplary embodiments, the stamped rivet 10, 10′ comprises a material, which is harder than the sheet metal material to which the connection is to be made via the stamped rivet. In both cases, the stamped rivet 10, 10′ is not deformed by the placement process. Only the sheet metal material is deformed, to which the connection is to be made. During the production of the connection, the sheet metal material is plastically deformed into the circumferential groove 16, 16′. This results in a form-fitting connection between the stamped rivet 10, 10′ and the material of the sheet metals 24, 26, which is thus enclosed in the circumferential groove 16, 16′ between the planar surface 20, 20′ and a shoulder formed by the straight line 38 and the radius R3, respectively.

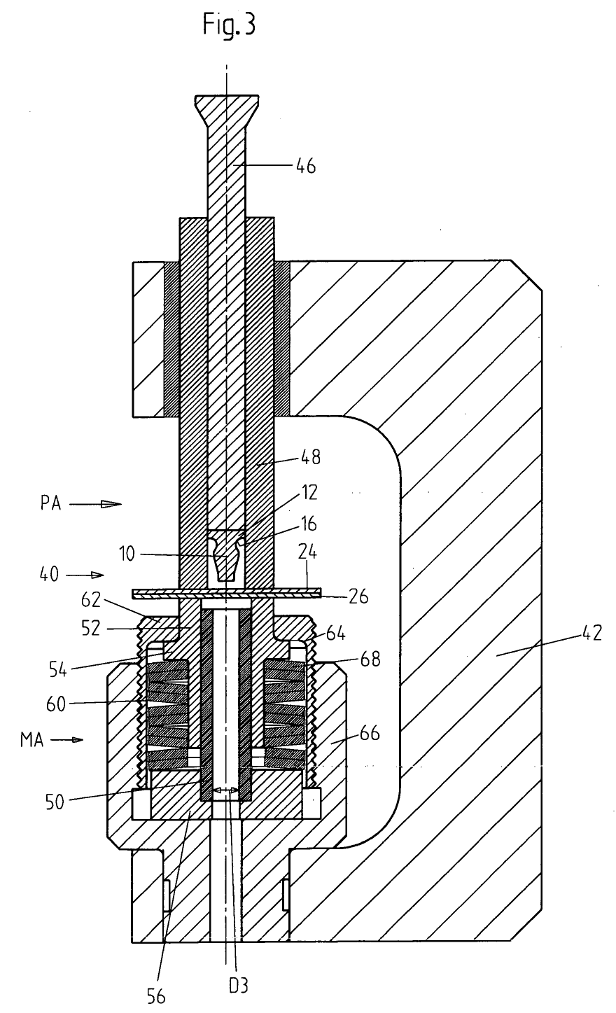

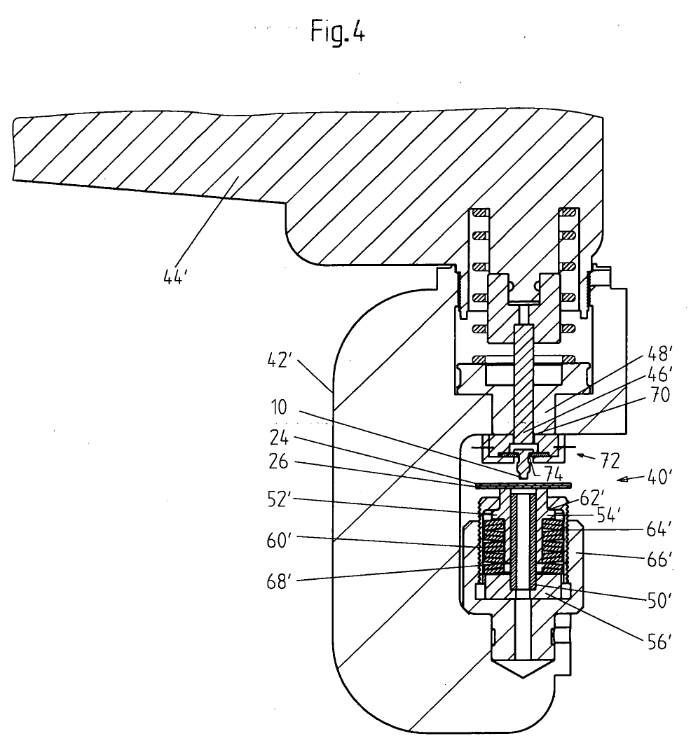

FIG. 3 shows a first embodiment of a device, indicated as 40 in its entirety, for placing a stamped rivet, here the stamped rivet 10, 10′. The device 40 comprises a male stamping tool, indicated as PA in its entirety, and a stamping seat, indicated as MA in its entirety, between which the two metal sheets 24, 26 are clamped, shown in the representation of FIG. 3 to be connected to one another by the stamped rivet 10. The male stamping tool and the stamping seat are connected to one another by a U-shaped yoke 42. It is discernible from FIG. 4 that the yoke 42′ can be mounted to an electrically, hydraulically, or pneumatically driven tool 44′, which drives the stamp 46′ during the placing process. The drive of the stamp 46 is not shown in FIG. 3. In FIG. 3, the drive may be embodied similar to the one shown in FIG. 4 or may occur manually, for example via a hammer.

In the device 40 according to FIG. 3, the male stamping tool PA is provided with an upper socket 48, which accepts the stamp 46 and the stamped rivet 10 in a shiftable manner, and which itself is held in the yoke 42 either fixed or displaceable. The stamping tool MA is provided with a fixed lower socket 50, which is distanced from the upper socket 48, and which accepts the shaft 14 of the stamped rivet 10 during the stamping process. The lower socket 50 is surrounded by a slightly elastical, pre-tensioned clamping bushing 52, which protrudes from the lower socket 50 in the direction towards the stamp 46, and which serves as a support for the metal sheets 24, 26 that are to be connected to one another by the stamped rivet 10.

The stamp 46 of the device 40 has a diameter equivalent to the diameter of the head 12 of the stamped rivet 10. The fixed lower socket 50 has an exterior diameter larger than the diameter of the head 12 of the stamped rivet 10. The lower socket 50 has an interior diameter D3. The interior diameter D3 is equivalent to the diameter D2 of the cylindrical shaft section 30 or slightly larger than the diameter D2. The exterior diameter of the lower socket 50 exceeds the diameter of the head 12 of the stamped rivet 10 by the difference between the diameter of the head 12 and the largest diameter D2 of the shaft 14 of the stamped rivet 10, i.e. the diameter D2 of the cylindrical shaft section 30. The detail of the device 40, additionally represented in FIG. 2a, shows that the above-mentioned diameters are dimensioned such that sufficient space is available for the plastic deformation of the metal sheets 24, 26 in the area of the circumferential groove 16. According to FIGS. 3 and 4, the clamping bushing 52, 52′ is provided with a circular shoulder 54, 54′, which is elastically pre-tensioned against a stop 62, 62′ by a spring member 60, 60′, arranged between a counter bearing 56, 56′, at which the lower socket 50, 50′ is mounted, and the circular shoulder 54, 54′, said stop being formed by a shoulder of an interior threaded socket 64, 64′, into which an exterior threaded socket 66, 66′ of the stamping tool MA is screwed. In the exemplary embodiment shown the spring member 60, 60′ is formed by several cup springs 68, 68′ stacked on top of one another.

In addition to a different type of drive, the exemplary embodiment of the device 40′ according to FIG. 4 varies from the exemplary embodiment of the device 40 according to FIG. 3 in that a guiding member for the stamped rivet—magazine strip 74, named 72 in its entirety, is mounted to a stamp exit end 70 of the upper socket 48′.

The method for placing the stamped rivet 10 using the device 40, in which the stamped rivet is driven without any pre-drilling through the metal sheets 24, 26, forming a punched hole, and subsequently sheet metal material is forced into the circumferential groove 16, being plastically deformed, is performed as follows. First, the stamped rivet 10 is forced downward with the help of the stamp 46, until it contacts the metal sheet 24. Subsequently the sheet metals 24, 26 and the clamping sleeve 52 are displaced downward by way of the stamp 46 and the stamped rivet 10, against the force of the cup springs 68, until the metal sheet 26 contacts the surface of the lower socket 50. From there on, the stamp 46 continues to move the stamped rivet 10 only and the stamping of the punched hole occurs by the cylindrical end section 28 of the stamped rivet 10. During the formation of the punched hole the sheet metal material in a first circular area surrounding the punched hole is taken along in the stamping direction. Hereby, the edge sections of the punched hole are deformed downward. As soon as the sheet metals 24, 26 have been stamped, tensions release, reactivating the forces of the cup springs 68. They again displace the clamping sleeve 52 and the sheet metals 24, 26 upward to the extent the forces of the cup springs 68 are capable to shift the sheet metals 24, 26 upwards over the tapering section 22 of the stamped rivet 10 widening towards the top. Assuming sufficient force of the cup springs 68, the limit would be reached when the metal sheet 24 contacts the bottom of the upper socket 48. The metal sheets 24, 26 have thus been lifted off the lower socket 50, so that the sheet metals 24, 26 and the upper side of the lower socket 50 are separated. During this process the stamp 46 has been moved forward continuously. Due to the sudden release of the force of the cup springs 68, the metal sheets 24, 26 have been shifted relatively far upwards on the stamped rivet 10 in said punched hole. Due to the continuous pressure acting onto the stamped rivet 10 by the stamp 46, said stamped rivet is finally forced farther downward through the punched hole until the planar surface 20 of the head 12 contacts the upper side of the metal sheet 24. From now on, the stamped rivet 10 and the sheet metals 24 26 are displaced together downward until the metal sheet 26 contacts the upper side of the lower socket 50. Now the edge regions of the punched hole, which were deformed downwards, are plastically deformed into the circumferential grooves 16 in a first circular area B1 (FIG. 2a), by way of the stamp 46 on the lower socket 50 serving as a fixed counter support. FIG. 2a shows the final state of this deformation. During this deformation, a second circular area B2, surrounding the lower socket 50, is elastically supported by the clamping bushing 52. The sheet metal material is compressed during the deformation in the first circular area B1 to the length L of the circumferential groove 16. The metal sheets 24, 26 to be connected to one another or the thin metal sheet to be connected to the stamped rivet 10 preferably have a total thickness smaller than the length L of the circumferential groove 16. However, the overall thickness could also be greater than the length L of the circumferential groove 16. Due to the placement method according to the invention, the sheet metal material in the preferred exemplary embodiment shown experiences a thickening in the area of the circumferential groove 16 over the length L.

The placement process using the device 40′ according to FIG. 4 essentially proceeds in the same manner as the device 40 shown in FIGS. 3 and 4 such that during the placement process the metal sheets 24, 26 are not required to be clamped between the stamping tool MA and the male counterpart PA. Both in the device 40 according to FIG. 3 as well as in the device 40′ according to FIG. 4, the stamp 46, 46′ moves the stamped rivet 10, 10′ downward during the placement process, with said stamped rivet forcing the clamping bushing 52, 52′ downward against the force of the spring member 60, 60′ while punching through the metal sheets 24, 26 until the metal sheet 26 contacts the surface of the lower socket 50, 50′ and with the sheet metal material, during the formation of the punched hole, being taken along in the stamping direction in a first circular area surrounding the punched hole. At this moment, the counterforce of the spring member 60, 60′ begins to exceed the force acting from above so that the clamping bushing 52, 52′ is abruptly forced upward in order to deform the sheet metal material in the first circular area B1 upward and into the circumferential groove 16, 16′. The stamping process and the deformation of the sheet metal material occur in the above-described manner.

1. A stamped rivet for connection of sheet metal comprising a head, an adjacent shaft, a circumferential groove formed in said shaft, and a shaft end opposite to said head, wherein the head (12, 12′) is provided on a bottom thereof with a circular planar surface (20, 20′) facing the shaft (14, 14′), the circumferential groove (16, 16′) is directly adjacent to the bottom of the head (12, 12′), and a section of the shaft (14, 14′) in an area located between the circumferential groove (16, 16′) and the shaft end (18, 18′) conically tapers towards the shaft end (18, 18′) forming a tapering section.

2. A stamped rivet according to claim 1, wherein the tapering section (22) extends to a cylindrical end section (28) of the shaft (14).

3. A stamped rivet according to claim 1, wherein the tapering section (22′) extends to the end of the shaft (18′).

4. A stamped rivet according to claim 1, wherein the tapering section (22, 22) is directly adjacent to the circumferential groove (16, 16′).

5. A stamped rivet according to claim 1, wherein a cylindrical section of the shaft (30, 30′) is directly adjacent to the circumferential groove (16, 16′) and extends to the tapering section (22, 22′) of the shaft (14, 14′).

6. A stamped rivet according to claim 1, wherein the circumferential groove (16, 16′) extends to a longitudinal center (M, M′) of the stamped rivet (10, 10′).

7. A stamped rivet according to claim 1, wherein the tapering section (16, 16′) of the shaft (14, 14′) has an axial length (V, V′) generally equivalent to an axial length (L, L′) of the circumferential groove (16, 16′).

8. A stamped rivet according to claim 1, wherein the circumferential groove (16, 16′) converges via a first radius (R1) into the planar surface (20, 20′) at the bottom of the head (12, 12′).

9. A stamped rivet according to claim 1, wherein the circumferential groove (16, 16′) has, with reference to a longitudinal axis (34, 34′) of a central area (36, 36′) of the stamped rivet (10, 10′), a base parallel to the longitudinal axis (34, 34′).

10. A stamped rivet according to claim 1, wherein the circumferential groove (16) converges into an adjacent shaft section (30) via a straight line (38) tilted in reference to the longitudinal axis (34) of the stamped rivet (10).

11. A stamped rivet according to claim 9, wherein the base of the circumferential groove (16) converges via a second radius (R2) into a straight line (38).

12. A stamped rivet according to claim 1, wherein the circumferential groove (16) converges via a third radius (R3) into an adjacent shaft section (30′).

13. A stamped rivet according to claim 2, wherein the tapering section (22) converges via a fourth radius (R4) into the cylindrical end section (28).

14. A stamped rivet according to claim 5, wherein the cylindrical shaft section (30) converges via a fifth radius (R5) into the tapering section (22).

15. A stamped rivet according to claim 1, wherein the end of the shaft (18) is provided with sharp edges.

16. A stamped rivet according to claim 2, wherein the cylindrical end section (28) of the shaft (14) has a diameter (D1) equivalent to or slightly smaller than a smallest diameter (d) of the shaft (14) in an area of the circumferential groove (16).

17. A stamped rivet according to claim 1, wherein an axial length (L, L′) of the circumferential groove (16, 16′) is adapted to be greater than a thickness of a metal sheet or a total thickness of metal sheets (24, 26) to which a connection is to be made.
